(19) United States
(12) Patent Application Publication
(10) Pub. No.: US 2013/0120340 A1
(43) Pub. Date: May 16, 2013

(54) LIQUID CRYSTAL DISPLAY DEVICE

(71) Applicant: Funai Electric Co., Ltd., Osaka (JP)

(72) Inventors: Hiroshi YAMASHITA, Osaka (JP); Hisaharu OURA, Osaka (JP)

(73) Assignee: Funai Electric Co., Ltd., Osaka (JP)

(21) Appl. No.: 13/665,432

(22) Filed: Oct. 31, 2012

(30) Foreign Application Priority Data
Nov. 14, 2011 (JP) 2011-248261

(51) Int. Cl. G09G 5/00; G09G 3/36

(52) U.S. Cl. 345/211; 345/87

(57) ABSTRACT

A liquid crystal display device includes a liquid crystal cell, a gate driver, a source driver and a controller. The liquid crystal cell has a plurality of source lines, a plurality of gate lines, and a plurality of pixels. The pixels define a pixel region with a set of pixels. The source driver has a plurality of second output lines. The second output lines are connected to source lines to output voltage to the pixels. The source lines have a pair of common source lines that are connected to the set of pixels of the pixel region. The common source lines are further commonly connected to one of the second output lines of the source driver. The controller is further configured to display a predetermined color in the set of pixels of the pixel region.

### CROSS-REFERENCE TO RELATED APPLICATIONS

This application claims priority to Japanese Patent Application No. 2011-248261 filed on Nov. 14, 2011. The entire disclosure of Japanese Patent Application No. 2011-248261 is hereby incorporated herein by reference.

### BACKGROUND

1. Field of the Invention

The present invention generally relates to a liquid crystal display device.

2. Background Information

There is a liquid crystal cell that employs a wiring pattern (hereinafter also referred to as a “zigzag pattern”) with which drive voltage is supplied to the pixels that make up a pixel column in a screen, alternately from the source lines on both sides of the pixel column, rather than supplying drive voltage from a single source line to the source electrodes of the pixels that make up the pixel column.

As an example, there is a known configuration of a display panel that is compatible with full high definition (full HD) in which there are 1920×1080 pixels (see Japanese Laid-Open Patent Application Publication No. 2009-122679, for example). Each of the pixels has three sub-pixels corresponding to red (R), green (G), and blue (B). With this display panel, 5760 (i.e., 1920×3) data lines (e.g., source lines) are required as vertical display lines, and there is an additional 5761st data line.

### SUMMARY

A source driver, which supplies voltage for driving source electrodes of thin film transistors (TFT) or other such active elements provided to the pixels, is connected to the source lines of the liquid crystal cell. A set number (such as 720) of output lines (output channels) are provided to a single source driver. A liquid crystal cell equipped with a specific number (such as 5760) of source lines can be driven by installing a plurality of (such as eight) of these source drivers in a liquid crystal display device. However, with the liquid crystal cell employing the above-mentioned zigzag pattern, there are more source lines than when the zigzag pattern is not employed. Accordingly, the total number of output lines of source drivers installed in the liquid crystal display device does not meet the number of source lines in the liquid crystal cell that employs this zigzag pattern.

It has been discovered that a case such as this is handled by giving one of the plurality of source drivers the function of being able to switch the number of output channels so as to be able to accommodate not only the above-mentioned set number of source lines, but also a number greater than this. However, providing one of the source drivers installed in a product with a switching function such as this entails greater development time and cost, which makes it difficult to meet the need for faster and less expensive product development and manufacture.

One object of the present disclosure is to provide a liquid crystal display device with which it is possible to reduce manufacturing cost while employing a zigzag pattern wiring.

In view of the state of the know technology, a liquid crystal display device includes a liquid crystal cell, a gate driver, a source driver and a controller. The liquid crystal cell has a plurality of source lines that extend in a first direction of the liquid crystal cell and are arranged along a second direction of the liquid crystal cell with the second direction being perpendicular to the first direction, a plurality of gate lines that extend in the second direction and are arranged along in the first direction, and a plurality of pixels that are arranged in the first direction and the second direction and are connected to the source lines and the gate lines with the pixels defining a pixel region with a set of pixels that are arranged along the first direction. The gate driver has a plurality of first output lines. The first output lines are connected to the gate lines to output voltage to the pixels. The source driver has a plurality of second output lines. The second output lines are connected to source lines to output voltage to the pixels. The controller is configured and arranged to control the gate driver and the source driver to display image. The source lines of the liquid crystal cell have a pair of common source lines that are connected to the set of pixels of the pixel region. The common source lines are further commonly connected to one of the second output lines of the source driver. The controller is further configured to display a predetermined color in the set of pixels of the pixel region.

Other objects, features, aspects and advantages of the present disclosure will become apparent to those skilled in the art from the following detailed description, which, taken in conjunction with the annexed drawings, discloses a preferred embodiment of a liquid crystal display device.

### BRIEF DESCRIPTION OF THE DRAWINGS

Referring now to the attached drawings which form a part of this original disclosure:

FIG. 1 is a block diagram of a liquid crystal display device in accordance with one embodiment;

FIG. 2 is a diagram illustrating a layout of pixels and wirings in a liquid crystal cell of the liquid crystal display device illustrated in FIG. 1;

FIG. 3 is a detailed diagram of a wiring connection of an outermost source line and a source driver of the liquid crystal display device illustrated in FIG. 1; and

FIG. 4 is a diagram illustrating an end pixel region of the liquid crystal cell of the liquid crystal display device illustrated in FIG. 1, with the end pixel region displaying black.

### DETAILED DESCRIPTION OF EMBODIMENTS

A preferred embodiment will now be explained with reference to the drawings. It will be apparent to those skilled in the art from this disclosure that the following descriptions of the embodiment are provided for illustration only and not for the purpose of limiting the invention as defined by the appended claims and their equivalents.

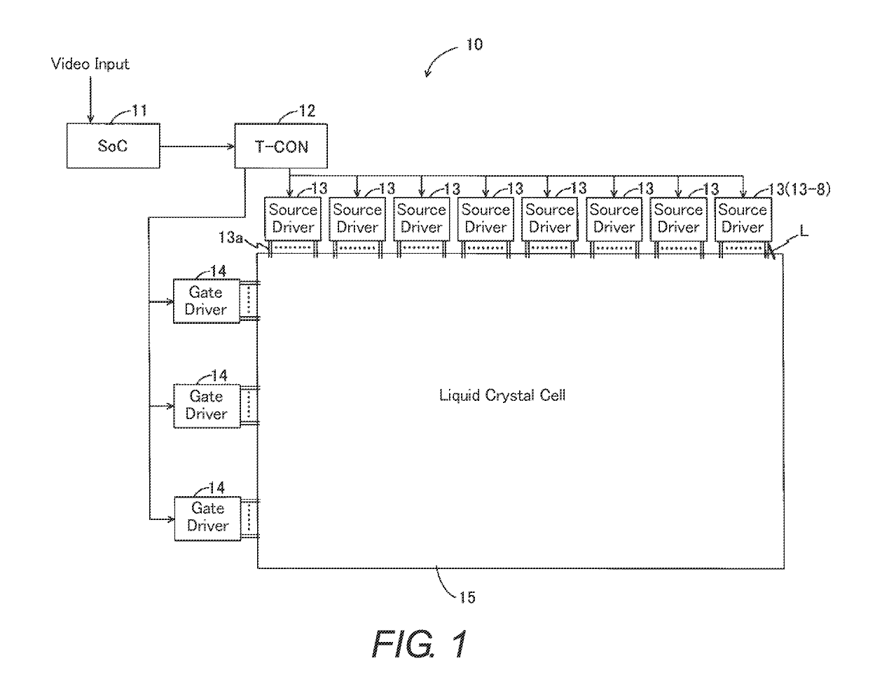

Referring to FIGS. 1 to 4, a liquid crystal display device 110 is illustrated in accordance with one embodiment. FIG. 1 is a block diagram of the liquid crystal display device 10. The liquid crystal display device 10 is a television set with a tuner having a function for receiving broadcast signals. Of course, the liquid crystal display device 10 can be any other type of display devices, such as a liquid crystal monitor that does not itself have the receiving function. Furthermore, the liquid crystal display device 10 can be incorporated as part of some kind of electrical product. The liquid crystal display device 10 includes a system-on-a-chip (SoC) 11 (e.g., a controller), a timing controller (T-CON) 12 (e.g., a controller), a plurality of source drivers 13 (e.g., a source driver), a plurality of gate drivers 14 (e.g., a gate driver), a liquid crystal cell or panel 15 (e.g., a liquid crystal cell), and so forth.

The SoC 11 is a one-chip integrated circuit for controlling the entire liquid crystal display device 10. The SoC 11 has a CPU and various kinds of memory, such as ROM, RAM, etc. The SoC 11 forms a controller of the prsent application. The SoC 11 inputs or obtains a video input (e.g., a signal input), such as broadcast signals or video signals, via a tuner or external input terminal (not shown). For example, the SoC 11 subjects the broadcast signal to decoding and extracts a video signal, or subjects an inputted or extracted video signal to specific correction or image quality adjustment. The SoC 11 outputs the resulting video signal to the T-CON 12. The T-CON 12 temporarily holds the inputted video signal in a frame memory (not shown) while controlling the source drivers 13 and the gate drivers 14 at a specific timing on the basis of the stored signal. The T-CON 12 also forms a controller of the present application. The transmission of the signal from the SoC 11 to the T-CON 12 is performed according to the INDS (i.e., low voltage differential signaling) communications standard, while the transmission of the signal from the T-CON 12 to the source drivers 13 and the gate drivers 14 is performed according to the mini-LVDS (i.e., low voltage differential signaling) communications standard, for example. Of course, the transmissions can be performed in any other suitable manner.

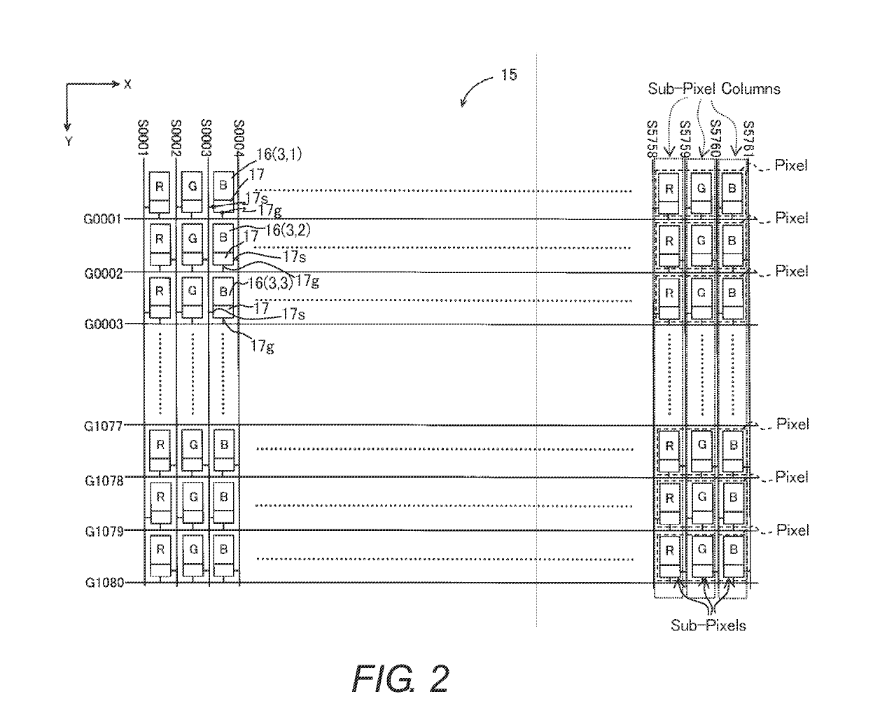

The liquid crystal cell 15 is an active matrix type of device, for example. In the liquid crystal cell 15, liquid crystal is sandwiched between two pieces of glass. Voltage is applied between opposing electrodes (i.e., pixel electrode and common electrode) with the liquid crystal in between, thereby changing the transmissivity or transmittance of light from a backlight disposed on a rear face of the liquid crystal cell 15. This light is passed through an RGB color filter so that colors are expressed. In the liquid crystal cell 15, as shown in FIG. 2, a plurality of source lines S0001 to S5761 (i.e., a total of 5761 of source lines) and a plurality of gate lines G0001 to G1080 (e.g., scanning lines) (e.g., a total of 1080 of gate lines) are disposed in a matrix on one of the pieces of glass, and a plurality of TFTs (i.e., thin film transistors) are installed as active elements for each sub-pixel. Specifically, the liquid crystal cell 15 is compatible with full high definition (full FID) in which there are 1920×1080 pixels. Each of the pixels has a plurality of (three in this embodiment) sub-pixels corresponding to red (R), green (G), and blue (B). With this display panel, 5760 (i.e., 1920×3) source lines and an additional 5761st source lines are provided.

FIG. 2 is a diagram illustrating a layout of the pixels and wiring patterns in the liquid crystal cell 15. The liquid crystal cell 15 mainly includes the source lines S0001 to S5761 and the gate lines G0001 to G1080. The source lines S0001 to S5761 are arranged along or arranged adjacently to one another in a X direction (e.g., a horizontal direction or a second direction) of the liquid crystal cell 15 and extend in a Y direction (e.g., a vertical direction or a first direction) of the liquid crystal cell 15 in a XY plane defined by the X and Y directions, which are perpendicular to one another. The gate lines G0001 to G1080 are arranged along or arranged adjacently to one another in the Y direction and extend in the X direction in the XY plane. The Y direction corresponds to a first direction of the present application, and the X direction corresponds to a second direction of the present application. As described above, the liquid crystal cell 15 has a plurality of (1920×1080 (X direction×Y direction) in this embodiment) pixels that are arranged in the X and Y directions. The pixels are connected to the source lines S0001 to S5761 and the gate lines G0001 to G1080. In particular, as mentioned above, the liquid crystal cell 15 has 5760×1080 (X direction×Y direction) sub-pixels. Each of the sub-pixels is compatible with the display of any of a plurality of element colors (i.e., three element colors RGB in this embodiment). Of course, the element colors that make up each of the pixels are not limited to the three colors of RGB. The element colors can instead be four colors of RGBY, in which yellow (Y) has been added, for example. A region combining a set of sub-pixels equivalent to the number of element colors (i.e., if the element colors are RGB, then an R sub-pixel, a G sub-pixel, and a B sub-pixel form a set of sub-pixels) arranged along the X direction can form a single pixel.

Each of these sub-pixels has a pixel electrode 16 and a TFT 17. The TFT 17 is electrically connected to the pixel electrode 16 via a drain electrode. The TFT 17 has a gate electrode 17g and a source electrode 17s. The TFT 17 is electrically connected to corresponding one of the gate lines G0001 to G1080 via the gate electrode 17g. The TFT 17 is further electrically connected to corresponding one of the source lines S0001 to S5761 via the source electrode 17s. As shown in FIG. 1, the liquid crystal display device 10 has the source drivers 13 and the gate drivers 14. Each of the gate drivers 14 has a plurality of (a set number) output lines (e.g., first output lines). In other words, in this embodiment, the gate drivers 14 have the same number of output lines, respectively. The gate drivers 14 electrically connect the output lines in a one-to-one correspondence with the gate lines G0001 to G1080 on the liquid crystal cell 15 side to output voltage to the pixels. In particular, the gate drivers 14 output voltage to the gate electrodes 17g via the output lines. In this embodiment, separate gate drivers 14 form a gate driver of the present application. However, the gate drivers 14 can be formed as a single gate driver. Also, each of the source drivers 13 has a plurality of (a set number) output lines 13a (e.g., second output lines). In other words, in this embodiment, the source drivers 13 have the same number of output tines 13a, respectively. The source drivers 13 electrically connect the output lines 13a in a one-to-one correspondence with the source lines S0001 to S5760 on the liquid crystal cell 15 side to output voltage to the pixels. In particular, the source drivers 13 output voltage to the source electrodes 17s via the output lines 13a. In this embodiment, separate source drivers 13 form a source driver of the present application. However, the source drivers 13 can be formed as a single source driver. With the liquid crystal display device 10 here, each of the source drivers 13 has 720 output lines 13a. A total of eight source drivers 13 (total number of output lines 720×8=5760) are used and connected to the source lines S0001 to S5760, respectively, on the liquid crystal cell 15 side.

The gate drivers 14 are controlled by the T-CON 12, and pulsed voltage is outputted to the gate lines G0001 to G1080 in the order of the gate lines G0001 to G1080 to switch on the TFTs 17 of the sub-pixels to display image. The source drivers 13 receive color data for each of the sub-pixels (with six bits of digital data) from the T-CON 12, produce application voltage for supply to the pixel electrodes 16 through the TFTs 17 in the turn-on state, and output this to the source lines S0001 to S5760 to display image. The level of this application voltage corresponds to the grayscale value (e.g., 64 shade grayscale) of the above-mentioned color data, and the transmissivity or transmittance of light in the sub-pixels varies with this application voltage. With this configuration, the sub-pixels of the liquid crystal cell 15 are driven to obtain an image display on the liquid crystal display device 10. Naturally, in addition to the configuration discussed above, the liquid crystal display device 10 can also have a known configuration which can comprise a power supply circuit, audio circuit, or the like as a liquid crystal television set or a liquid crystal monitor.

As can be seen from FIG. 2, the liquid crystal cell 15 employs a wiring pattern in a zigzag manner (i.e., a zigzag pattern) in which the sub-pixels (or pixels) that make up a sub-pixel column (or a pixel column) extending in the V direction are electrically and alternately connected to corresponding one of adjacent pairs of the source lines on both sides of this sub-pixel column after every specific number (e.g., an integer of one or more). For example, as shown in FIG. 2, a B sub-pixel column extends in the Y direction. The B sub-pixel column has a B sub-pixel for which a coordinate position (X, Y) of the pixel electrode 16 in the XY plane is specified by (3, 1). The source electrode 17s of the TFT 17 of this sub-pixel at the top coordinate position (3, 1) in this column of the B sub-pixels is electrically connected to the source line S0003, out of the source lines S0003 and S0004 sandwiching this column. Furthermore, the source electrode 17s of the TFT 17 of the B sub-pixel at the second highest coordinate position (3, 2) is electrically connected to the source line S0004, the source electrode 17s of the TFT 17 of the B sub-pixel at the third highest coordinate position (3, 3) is electrically connected to the source line S0003, and so on. In other words, the source lines (e.g., S0003 and S0004) to be connected to the B sub-pixels alternately change on the left and right every time there is a change (by the specific number (one in this embodiment)) in a position of the B sub-pixels in the Y direction. This type of connection between the sub-pixels and the source lines in the zigzag pattern is employed for all the columns of the sub-pixels extending in the Y direction.

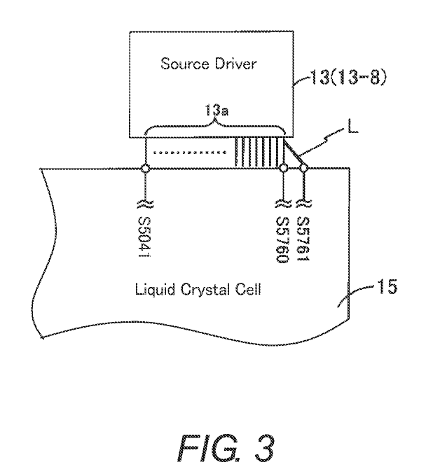

The result of employing this zigzag pattern is that the number of source lines S0001 to S5761 in the liquid crystal cell 15 is 5761, which is greater by one than the number of the sub-pixels (i.e., 5760 or number of sub-pixel columns) of the liquid crystal cell 15 arranged in a row in the X direction. Also, the number of the source lines S0001 to S5761 in the liquid crystal cell 15 is greater by one than the total number of output lines 13a (i.e., 5760) from the eight source drivers 13. Accordingly, if the eight source drivers 13 and the source lines S0001 to S5761 of the liquid crystal cell 15 are merely connected, a source line S5761 (e.g., an outermost source line) that is located outermost of the source lines S0001 to S5761 in the X direction on the liquid crystal cell 15 (e.g., one specific side out of the two ends in the X direction) will end up being left over. In other words, there will be no connecting output line 13a for the source line S5761. In this situation, with this embodiment, as shown in FIGS. 1 and 3, the source line S5761 is electrically connected to one of the output lines 13a of the source driver 13 to which an adjacent source line S5760 that is directly adjacent to the source line S5761 is electrically connected. In other words, the outermost source line S5761 and the adjacent source line S5760 form a pair of common source lines of the present application, and are commonly connected to the one of the output lines 13a of the source driver 13. The source driver 13 to which the adjacent source line S5760 is electrically connected is the outermost source driver 13-8 to which the source lines S5041 to S5760 are electrically connected (see FIG. 1). The outermost source line S5761 is electrically connected or shorted by a wiring connection L to the outermost output line 13a of this source driver 13-8 (i.e., the output line 13a to which the adjacent source line S5760 is electrically connected). More specifically, the wiring connection L is directly connected to the outermost output line 13a of the source driver 13-8 at a connecting point outside the liquid crystal cell 15. The connecting point between the wiring connection L and the outermost output line 13a of the source driver 13-8 defines a branch of the electrical connection between the outermost output line 13a and the adjacent source line S5760, which also electrically and constantly connects the outermost output line 13a with the outermost source line S5761 via the wiring connection L. In this embodiment, the phrase “electrically connected” or “connected” means that wiring elements are physically and constantly connected to make an electrical connection without having any transistors or switches therebetween.

With this configuration, the source lines S5760 and S5761 are electrically connected to the same output line 13a by the wiring connection L. In this embodiment, during performing image display on the liquid crystal cell 15, a black display is executed in an unit region (e.g., a pixel region) of the liquid crystal cell 15. The unit region of the liquid crystal cell 15 has a set of the pixels that are arranged in the Y direction. The set of the pixels forms a vertical line on the liquid crystal cell 15 extending in the Y direction. The outermost source line S5761 and the adjacent source line S5760 are connected to the set of the pixels of the unit region. The set of the pixels of the unit region is displayed in black (e.g., a predetermined color). Furthermore, the set of pixels of the unit region includes or defines a plurality of sub-pixel columns that extend in the Y direction. Each of the sub-pixel columns has a plurality of sub-pixels that are arranged in the Y direction. The sub-pixel columns correspond to a plurality of different element colors (RGB in this embodiment), respectively. In particular, the unit region includes a sub-pixel column (e.g., a first column) of the sub-pixels to which the source lines S5760 and S5761 are electrically and alternately connected (i.e., the outermost column of the B sub-pixels in the liquid crystal cell 15), and a plurality of sub-pixel columns (e.g., a plurality of second columns) of the sub-pixels corresponding to different element colors that are arranged continuously and adjacent relative to the sub-pixel column of the sub-pixels to which the source lines S5760 and S5761 are connected. More specifically, the black display is executed in the unit region (or end pixel region) having the outermost column of the B sub-pixels, and two columns of the sub-pixels that are continuous with or adjacent to the outermost column in the X direction. The two columns of the sub-pixels correspond to two element colors R and (ii) out of RGB, other than the element color (i.e., B) to which the outermost column of the sub-pixels corresponds. More specifically, the two columns includes a column of G sub-pixels extending in the Y direction and located adjacent to the outermost column of the B sub-pixels, and a column of R sub-pixels extending in the Y direction and located adjacent to the column of the G sub-pixels. Said shortly, the unit region or end pixel region of the liquid crystal cell 15 is formed by a line or column of outermost pixels disposed along an edge of the liquid crystal cell 15, with each of the outermost pixels including three sub-pixels (i.e., R sub-pixel, G sub-pixel and B sub-pixel) arranged adjacently to one another in the X direction.

More specifically, when the SoC 11 receives the video input, the SoC 11 process the video input to forcibly convert the color of the end pixel region to black such that the end pixel region is displayed in black irrelevant to the video input. Then, the SoC 11 output the video signal (processed video input) to the T-CON 12. That is, the SoC 11 functions as a controller for performing the black display. As a result, the liquid crystal display device 10 displays image in the pixels other than the end pixel region according to the video input that is inputted to the SoC 11, and display black in the end pixel region irrelevant to the signal input. Alternatively, the T-CON 12 can also process the video signal by forcibly converting the color of the end pixel region to black for the video signal inputted from the SoC 11, and control the source drivers 13 and the gate drivers 14 on the basis of this processed video signal. That is, in this case, the T-CON 12 can function as a controller for performing the black display. Here, the phrase “black display” means displaying black image on the pixels of the liquid crystal cell 15 no matter what video signal is inputted for the pixels of the liquid crystal cell 15.

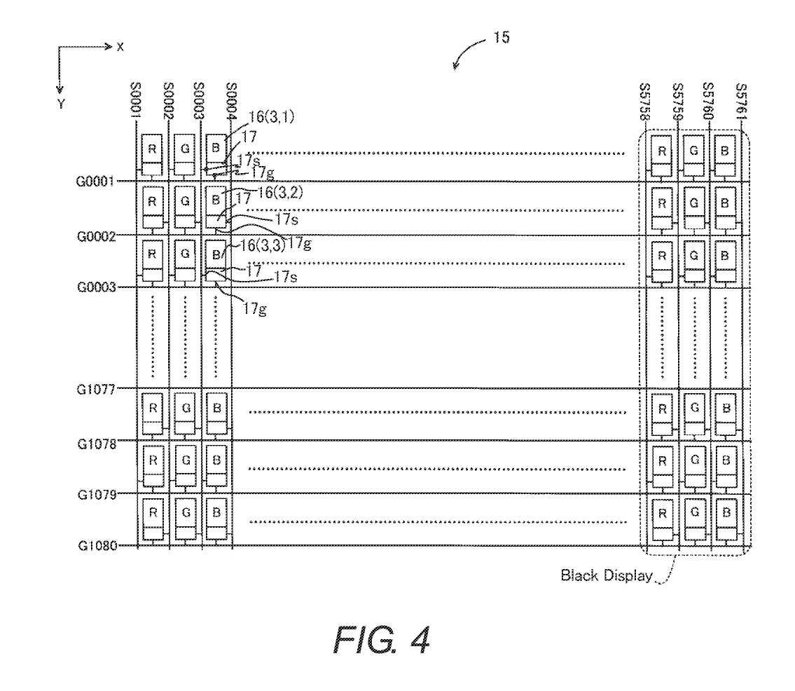

FIG. 4 is a diagram illustrating how the end pixel region is put in black display. As shown in FIG. 4, the encircled area encircled by the dotted line is the end pixel region of the liquid crystal cell 15. As a result of the above-mentioned processing by the controller (i.e., the SoC 11 and/or T-CON 12), the source driver 13 (13-8) produces and outputs application voltage for achieving the minimum grayscale (i.e., black) in the sub-pixels that make up the end pixel region. As a result, the light from the backlight of the liquid crystal display device 10 is not transmitted through at any of the sub-pixels that make up the end pixel region, thereby achieving the black display. As to the source line S5761, there is no corresponding output line 13a on the source driver 13 (13-8) side. However, the source lines S5760 and S5761 are commonly connected in parallel to the same output line 13a of the source driver 13-8 by the wiring connection L as discussed above. Thus, the sub-pixels connected to the source line S5761 (i.e., the outmost B sub-pixels in the end pixel region that are also connected to the gate lines G0002, . . . , G1077, and G1080) are maintained at the same potential as the sub-pixels connected to the source line S5760 (i.e., the outmost B sub-pixels in the end pixel region that are also connected to the gate lines G0001, . . . , and G1079), and all of these sub-pixels are maintained in a non-transmitting state (i.e., black). The end pixel region is an extremely narrow region, only three columns of the sub-pixels extending in the Y direction, at the very end of the liquid crystal cell 15 in the X direction. Thus, even though this region is forcibly displayed in black as mentioned above, the difference is virtually unnoticeable to the user between the case of this black display and the case in which all of the sub-pixels including the end pixel region are driven according to the original video signals obtained by the SoC 11 by providing to the source drivers 13 the same total number of output lines as the total number of the source lines S0001 to S5761 such that all of the output lines of the source drivers 13 are connected in a one-to-one correspondence with the source lines S0001 to S5761 on the liquid crystal cell 15 side. Therefore, the displayed image on the liquid crystal display device 10 looks natural to the user even with this black display. Of course, normal display based on the video signal is performed in the display region of the liquid crystal cell 15 other than the end pixel region.

On the other hand, if the outermost source line S5761 is not connected to any of the output lines of the source drivers 13, the sub-pixels connected to the outermost source line S5761 transmit the light, instead of preventing the transmission of the light and displaying black, such that the corresponding color of these sub-pixels (Blue in this embodiment) is constantly displayed on the liquid crystal cell 15 at the locations of these sub-pixels. This does not look natural to the user. Therefore, the black display as mentioned above is preferable relative to this by connecting the outermost source line S5761 to the output line 13a of the source driver 13-8. Of course, the color displayed on the end pixel region is not limited to black. Any other colors (e.g., predetermined colors), such as white, red, blue, green, and so forth, can be forcibly displayed on the end pixel region.

With this liquid crystal display device 10, the outermost source line S5761 is connected by the wiring connection L to the output line 13a of the source driver 13-8 to which the adjacent source line S5760 is connected. However, the present application is not limited to this. The outermost source line S5761 can be commonly connected to the output line 13a of the source driver 13 to which a “nearby” source line (e.g., another source line) is electrically connected. In particular, the outermost source line S5761 is connected by the wiring connection L to the output line 13a of the source driver 13 (13-8) to which is connected one of the other source lines (e.g., S5758, S5759, S5760) connected to the columns of the sub-pixels forming the unit region (i.e., the end pixel region) in which the above-mentioned black display is to be executed. In other words, the case of a “nearby” source line near the source line S5761 encompasses one of the source lines S5758, S5759, and S5760. However, since the source line S5758 is also connected to a column of the sub-pixels that is not in the end pixel region, the “nearby source line near the source line S5761” refers to the source lines S5759 and S5760. In the illustrated embodiment, the outermost source line S5761 is connected to the adjacent source line S5760 that is directly adjacent to the outermost source line S5761. Alternatively, the adjacent source line S5760 can be connected to the output line 13a of the source driver 13-8 that is connected to the source line S5758 or S5759, or the source line S5759 can be connected to the output line 13a of the source driver 13-8 that is connected to the source line S5758. Then, the sub-pixels in the end pixel region are driven to perform the black display as mentioned above.

In the illustrated embodiment, since the zigzag pattern is employed as the wiring pattern of the liquid crystal cell 15, there is one more source line in the liquid crystal cell 15 than the total number of the output lines 13a of the source drivers 13. Under this circumstances, rather than independently controlling the outermost source line S5761, the outermost source line S5761 is connected to the common output line 13a along with one of the nearby source lines (i.e., S5758, S5759 and S5760), and the black display can be performed in the end pixel region including the columns of the sub-pixels to which the outermost source line S5761 and the nearby source lines S5758, S5759 and S5760 are connected. Accordingly, there is no need to specially develop and install a source driver capable of switching the number of output channels so as to be able to accommodate different numbers of source lines. As a result, it is possible to manufacture the liquid crystal display device 10 with which image display that looks natural to the user can be performed quickly and at low cost.

In the illustrated embodiment, a liquid crystal display device includes a liquid crystal cell, a gate driver, a source driver, and a controller. The liquid crystal cell has a plurality of source lines that extend in a first direction and are arranged in a second direction that is perpendicular to the first direction, a plurality of gate lines that extend in the second direction and are arranged in the first direction, and a plurality of pixels that are arranged in the first direction and the second direction and are connected to the source lines and the gate lines. The gate driver has a set number of output lines. The output lines are connected to the gate lines. The gate driver outputs voltage to the pixels. The source driver has a set number of output lines. The output lines are connected to source lines. The source driver outputs voltage to the pixels. The controller performs image display by controlling the output of the gate driver and the source driver. The liquid crystal display device has a wiring pattern (a type of zigzag patter) in which sub-pixels that make up a sub-pixel column extending in the first direction are alternately connected to source lines on both sides of the sub-pixel column at every specific number of pixels. The total number of the source lines in the liquid crystal cell is greater by one than the total number of the output lines in the source driver. The outermost source line in the liquid crystal cell is connected to the output line of the source driver to which the adjacent source line is connected. The controller executes black display in a region including the sub-pixel column to which the adjacent source line and the outermost source line are connected.

With this configuration, rather than trying to independently control the one source line that exceeds the total number of output lines of a source driver i.e., the outermost source line), it is connected to a common output line along with the adjacent source line, and is held at a potential that is the same as the potential provided to the adjacent source line. Furthermore, the black display is performed in a region including the sub-pixel column in which the outermost source line and the adjacent source line are connected. Thus, an image can be provided that looks natural to the user, and that is indistinguishable from an image in the case in which all of the sub-pixels including the end pixel region are driven according to the original video signals by providing to the source driver the same total number of output lines as the total number of the source lines such that all of the output lines of the source driver are connected in a one-to-one correspondence with the source lines on the liquid crystal cell side.

Furthermore, each of the sub-pixel columns corresponds to the display of one of a plurality of element colors. The black display is executed in a unit region that includes the sub-pixel column to which the outermost source line is connected, and a plurality of sub-pixel columns of different corresponding element colors that are formed continuously. The outermost source line is connected to the output line of the source driver connected to another source line that is connected to any of the sub-pixel columns forming the unit region in which the black display is executed.

Moreover, the above-mentioned sub-pixels of the liquid crystal cell are sub-pixels that connect source electrodes of active elements to the source lines and connect gate electrodes of active elements to the gate lines. Each sub-pixel corresponds to the display of a red, green, or blue element color. The gate driver connects the output lines to the gate lines and outputs voltage to gate electrodes of the active elements of the sub-pixels. The source driver connects the output lines to the source lines and outputs voltage to the source electrodes of the active elements of the sub-pixels. There is a wiring pattern in which the sub-pixels that make up the sub-pixel column extending in the first direction and corresponding to one element color of RBG are each alternately connected to source lines on both sides of the column. The outermost source line in the liquid crystal cell is connected to the output line of the source driver to which the adjacent source line is connected. The controller executes the black display in a region made of a first column of the sub-pixels to which the outermost source line and the adjacent source line are connected, and two second columns of the sub-pixels that are continuous with the first column in the second direction and correspond to two colors out of RGB, excluding the element color to which the first column corresponds.

With this liquid crystal display device, a liquid crystal display device can be provided with which product development and manufacture can be made faster and less expensive even when a zigzag pattern is employed, and with which image display that looks natural to the user is afforded.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided tier illustration only, and not for the purpose of limiting the invention as defined by the appended claims and their equivalents.

What is claimed is:

1. A liquid crystal display device comprising:
a liquid crystal cell having a plurality of source lines that extend in a first direction of the liquid crystal cell and are arranged along a second direction of the liquid crystal cell with the second direction being perpendicular to the first direction, a plurality of gate lines that extend in the second direction and are arranged along in the first direction, and a plurality of pixels that are arranged in the first direction and the second direction and are connected to the source lines and the gate lines with the pixels defiling a pixel region with a set of pixels that are arranged along the first direction;
a gate driver with a plurality of first output lines, the first output lines being connected to the gate lines to output voltage to the pixels;
a source driver with a plurality of second output lines, the second output lines being connected to source lines to output voltage to the pixels; and
a controller configured and arranged to control the gate driver and the source driver to display image,
the source lines of the liquid crystal cell having a pair of common source lines that are connected to the set of pixels of the pixel region, the common source lines being further commonly connected to one of the second output lines of the source driver,
the controller being further configured to display a predetermined color in the set of pixels of the pixel region.

2. The liquid crystal display device according to claim 1, wherein
the set of pixels of the pixel region further defines a plurality of sub-pixel columns that extend in the first direction, each of the sub-pixel columns having a plurality of sub-pixels that are arranged in the first direction.

3. The liquid crystal display device according to claim 2, wherein
the source lines of the liquid crystal cells are arranged such that the sub-pixels of each of the sub-pixel columns are alternately connected to corresponding one of adjacent pairs of the source lines on each side at every specific number of the sub-pixels.

4. The liquid crystal display device according to claim 1, wherein
the source lines have a total number that is greater by one than a total number of the second output lines of the source driver.

5. The liquid crystal display device according to claim 1, wherein
the common source lines have an outermost source line that is located outermost of the source lines in the second direction and an adjacent source line that is adjacent to the outermost source line, the outermost source line and the adjacent source line being commonly connected to the one of the second output lines of the source driver.

6. The liquid crystal display device according to claim 1, wherein
the controller is configured to display black in the set of pixels of the pixel region.

7. The liquid crystal display device according to claim 1, wherein
the controller is configured to display image in the pixels other than the set of pixels of the pixel region according to a signal input that is inputted to the controller, the controller being further configured to display the predetermined color in the set of pixels of the pixel region irrelevant to the signal input.

8. The liquid crystal display device according to claim 7, wherein
the controller is configured to display black in the set of pixels of the pixel region.

9. The liquid crystal display device according to claim 2, wherein
the sub-pixel columns of the liquid crystal cell correspond to a plurality of different element colors of the liquid crystal display device.

10. The liquid crystal display device according to claim 9, wherein
the sub-pixel columns of the liquid crystal cell has a first column of sub-pixels to which an outermost source line that is located outermost of the source lines in the second direction is connected, and a plurality of second columns of sub-pixels that are adjacent to the first column of sub-pixels.

11. The liquid crystal display device according to claim 10, wherein
the common source lines include the outermost source line and another source line that is connected to one of the sub-pixel columns of the set of pixels of the pixel region.

12. The liquid crystal display device according to claim 2, wherein
each of the sub-pixels includes an active element having a source electrode and a gate electrode, the source electrode being connected to respective one of the source lines, the gate electrode being connected to respective one of the gate lines, and
the sub-pixel columns correspond to red, green and blue element colors, respectively.

13. The liquid crystal display device according to claim 12, wherein
the gate driver is further configured to output voltage to the gate electrodes of the active elements of the sub-pixels via the first output lines, and
the source driver is further configured to output voltage to the source electrodes of the active elements of the sub-pixels via the second output lines.

14. The liquid crystal display device according to claim 13, wherein
the source lines of the liquid crystal cell are arranged such that the sub-pixels of each of the sub-pixel columns are alternately connected to corresponding one of adjacent pairs of the source lines on each side.

15. The liquid crystal display device according to claim 13, wherein
the sub-pixel columns of the liquid crystal cell has a first column of sub-pixels to which an outermost source line that is located outermost of the source lines in the second direction and an adjacent source line that is adjacent to the outermost source line are connected, and a pair of second columns of sub-pixels that are adjacent to the first column of sub-pixels in the second direction, with the first column of sub-pixels corresponding to one of the red, green and blue element colors, with the second columns of sub-pixels corresponding to two of the red, green and blue element colors other than the one of the red, green and blue element colors.
